(19) United States
(12) Patent Application Publication
(10) Pub. No.: US 2015/0338507 A1
(43) Pub. Date: Nov. 26, 2015

(54) RADAR SIGNAL PROCESSING METHOD AND APPARATUS

(71) Applicant: DAEGU GYEONGBUK INSTITUTE OF SCIENCE AND TECHNOLOGY, Daegu (KR)

(72) Inventors: Dae Gun OH, Daegu (KR); Cherl Hee LEE, Daegu (KR); Yeong Hwan JU, Yeongyang-gun (KR); Jong Hun LEE, Daegu (KR)

(21) Appl. No.: 14/717,415

(22) Filed: May 20, 2015

(30) Foreign Application Priority Data
May 21, 2014 (KR) 10-2014-0061070

(51) Int. Cl. G01S 7/35; G01S 7/02

(52) U.S. Cl. CPC G01S 7/354; G01S 7/023

(57) ABSTRACT

Provided is a radar signal processing method and apparatus, the method including transmitting a radar signal through a transmission antenna, receiving, through a reception antenna, a first reflection signal generated based on the radar signal reflected by an obstacle and a second reflection signal generated based on the radar signal reflected by a target located behind the obstacle, performing filtering by using a filter for removing the first reflection signal, and processing the second reflection signal extracted based on a result of the filtering.

### CROSS-REFERENCE TO RELATED APPLICATION

This application claims the priority benefit of Korean Patent Application No. 10-2014-0061070, filed on May 21, 2014, in the Korean Intellectual Property Office, the disclosure of which is incorporated herein by reference.

### BACKGROUND

1. Field of the Invention

Example embodiments of the present invention relate to a radar signal processing method and apparatus for filtering a reflection signal based on a separation distance between an obstacle and a reception antenna and a separation distance between a target and the reception antenna.

2. Description of the Related Art

A radar may be an apparatus for transmitting a radar signal through a transmission antenna and receiving a reflection signal reflected from an object in a corresponding area through a reception antenna, thereby detecting a presence of a target and a distance from the target. In this example, the radar signal may be modulated based on, for example, a pulse scheme, a frequency modulated continuous wave (FMCW) scheme, and a frequency shift keying (FSK) scheme. The radar may use a different method of extracting a speed of the target and the distance from the target based on a modulation scheme.

In contrast to a pulse scheme-based radar, an FMCW radar may transmit a radar signal modulated based on the FMCW scheme to a target. Thus, the FMCW radar may receive a reflection signal reflected from the target, thereby extracting a speed of the target and a distance from the target. The FMCW may be advantageous in terms of having a simple structure and a miniaturized size. Accordingly, the FMCW radar may be applied as a small radar for military purposes, a radar for altitude measurement purposes, and a vehicle collision preventing system.

In general, the FMCW radar may arrange a frequency of a radar signal to be transmitted to a target such that the frequency is linearly changed over time. Through this, the FMCW radar may extract a location of the target based on a frequency of a signal reflected from the target.

### Technical Goal

### SUMMARY

An aspect of the present invention provides a radar signal processing method and apparatus for receiving a first reflection signal reflected from an object and a second reflection signal reflected from a target located behind the obstacle, and filtering out the first reflection signal based on a difference in an attribute between the first reflection signal and the second reflection signal.

According to an aspect of the present invention, there is provided a radar signal processing method including transmitting a radar signal through a transmission antenna, receiving, through a reception antenna, a first reflection signal generated based on the radar signal reflected by an obstacle and a second reflection signal generated based on the radar signal reflected by a target located behind the obstacle, performing filtering by using a filter for removing the first reflection signal, and processing the second reflection signal extracted based on a result of the filtering.

The performing may include performing the filtering based on a frequency band of a result obtained by mixing a radar signal to the first reflection signal and a frequency band of a result obtained by mixing a radar signal to the second reflection signal.

The frequency band of the result obtained by mixing the radar signal to the first reflection signal may be determined based on a separation distance between the reception antenna and the obstacle, and the frequency band of the result obtained by mixing the radar signal to the second reflection signal may be determined based on a separation distance between the reception antenna and the target.

The radar signal may be modulated based on a frequency modulation continuous wave (FMCW) scheme.

The performing may include performing the filtering using a high pass filter for removing the first reflection signal.

According to another aspect of the present invention, there is also provided a radar signal processing apparatus including a transmitter configured to transmit a radar signal through a transmission antenna, a receiver configured to receive, through a reception antenna, a first reflection signal generated based on the radar signal reflected from an obstacle and a second reflection signal generated based on the radar signal reflected from a target located behind the obstacle, a filterer configured to perform filtering using a filter for removing the first reflection signal, and a processor configured to process the second reflection signal extracted based on a result of the filtering.

The filterer may be configured to perform the filtering based on a frequency band of a result obtained by mixing a radar signal to the first reflection signal and a frequency band of a result obtained by mixing a radar signal to the second reflection signal.

The frequency band of the result obtained by mixing the radar signal to the first reflection signal may be determined based on a separation distance between the reception antenna and the obstacle, and the frequency band of the result obtained by mixing the radar signal to the second reflection signal may be determined based on a separation distance between the reception antenna and the target.

The radar signal may be modulated based on an FMCW scheme.

The performing may include performing the filtering using a high pass filter for removing the first reflection signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a relationship between a radar signal processing apparatus and a target according to an example embodiment of the present invention;

FIG. 2 is a flowchart illustrating a method of processing a second reflection signal reflected from a target located behind an obstacle according to an example embodiment of the present invention;

FIG. 3 is a diagram illustrating an antenna transmission processing apparatus for transmitting a radar signal to a target located behind an obstacle according to an example embodiment of the present invention;

FIGS. 4A through 4C are diagrams illustrating a method of processing a radar signal modulated based on a frequency modulation continuous wave (FMCW) according to an example embodiment of the present invention;

FIG. 5 is a diagram illustrating an example of performing filtering by using a filter for removing a first reflection signal according to an example embodiment of the present invention; and

FIG. 6 is a block diagram illustrating a radar signal processing apparatus for performing a method of processing a second reflection signal reflected from a target located behind an obstacle according to an example embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

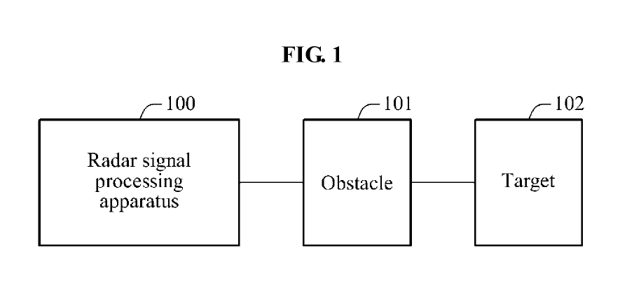

FIG. 1 is a block diagram illustrating a relationship between a radar signal processing apparatus 100 and a target 102 according to an example embodiment of the present invention.

The radar signal processing apparatus 100 may transmit a radar signal to the target 102 located behind an obstacle 101 using a transmission antenna. The radar signal processing apparatus 100 may correspond to transmission type radar. The obstacle 101 may include any object from which a radar signal is fully or partially reflected. As an example, the obstacle 101 may be a wall.

The radar signal may indicate, for example, a signal modulated based on a frequency modulation continuous wave (FMCW) scheme. The FMCW scheme may be, for example, a scheme of continuously transmitting a signal of which a frequency is modulated. In detail, the radar signal modulated based on the FMCW scheme may have a frequency changing over time. As an example, the radar signal modulated based on the FMCW scheme may have a frequency increasing proportionally to a time. In the present disclosure, a type of the radar signal is not limited to the foregoing, and may include any type of signal penetrating the obstacle 101.

When the radar signal reaches the obstacle 101, the radar signal may be reflected from the obstacle 101 or penetrate the obstacle 101. The radar signal reflected from the obstacle 101 may correspond to a first reflection signal. The radar signal penetrating the obstacle 101 may be reflected by the target 102. Also, the radar signal reflected from the target 102 may be reflected by the obstacle again, or penetrate the obstacle 101. The radar signal reflected from the target and penetrating the obstacle 101 may correspond to a second reflection signal.

The radar signal processing apparatus 100 may receive the first reflection signal and the second reflection signal through a reception antenna. In this example, the first reflection signal may include an attribute different from an attribute of the second reflection signal. The attribute may indicate any type of attribute generating a difference between signals. For example, the attribute may include a frequency, an intensity, a phase, and the like. Accordingly, the radar signal processing apparatus 100 may extract a desired result by removing one of the first reflection signal and the second reflection signal based on differing attributes.

As an example, when the radar signal processing apparatus 100 transmits the radar signal modulated based on the FMCW scheme, the first reflection signal may have a frequency band different from a frequency band of the second reflection signal. In this example, the radar signal processing apparatus 100 may filter out the first reflection signal using a filter. Through this, the radar signal processing apparatus 100 may determine location information on the target 102 by extracting the second reflection signal.

For example, the radar signal processing apparatus 100 may mix a radar signal to the received first reflection signal and second reflection signal. In this example, when the radar signal modulated based on the FMCW scheme is transmitted, a frequency of a reflection signal may be determined based on a separation distance between the radar signal processing apparatus 100 and a target from which the radar signal is reflected. As an example, a frequency of a second signal reflected from a target located behind an obstacle may be higher than a frequency of a first signal reflected from the obstacle. Thus, a frequency of a result obtained by mixing the radar signal to the first reflection signal may be higher than a frequency of a result obtained by mixing the radar signal to the second reflection signal. Also, the result obtained by mixing the radar signal to the first reflection signal and the result obtained by mixing the radar signal to the second reflection signal may have a constant frequency.

As an example, the radar signal processing apparatus 100 may filter out a signal having a frequency less than or equal to a cut-off frequency through a high pass filter (HPF) in which a fixed cut-off frequency is set. Thus, the radar signal processing apparatus 100 may filter out a signal reflected from a target located within a separation distance from the radar signal processing apparatus to correspond to the cup-off frequency. In detail, when the result obtained by mixing the radar signal to the first reflection signal is less than the cut-off frequency, the radar signal processing apparatus may filter out the result obtained by mixing the radar signal to the first reflection signal.

Alternatively, the radar signal processing apparatus 100 may extract the result obtained by mixing the radar signal to the second reflection signal by adjusting the cut-off frequency based on the separation distance between the target 102 and the radar signal processing apparatus 100. Accordingly, the radar signal processing apparatus 100 may extract the location information on the target 102 based on the extracted result obtained by mixing the radar signal to the second reflection signal.

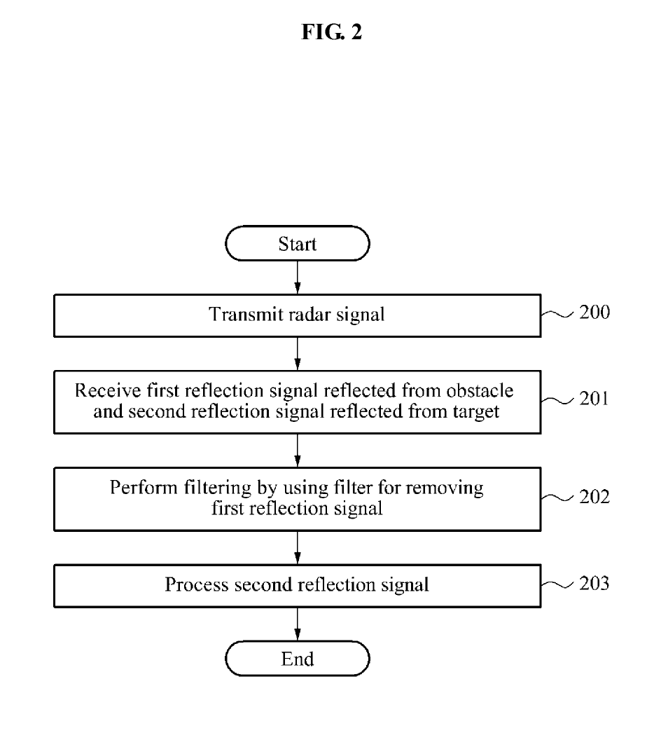

FIG. 2 is a flowchart illustrating a method of processing a second reflection signal reflected from a target located behind an obstacle according to an example embodiment of the present invention.

In operation 200, a radar signal processing apparatus may transmit a radar signal through a transmission antenna. For example, the radar signal processing apparatus may transmit the radar signal to a target located behind an obstacle through the transmission antenna. The target may reflect the radar signal penetrating the obstacle.

The radar signal processing apparatus may correspond to a radar. For example, the radar signal processing apparatus may correspond to a transmission type radar for transmitting and receiving a radar signal penetrating an obstacle. As an example, the radar signal processing apparatus may correspond to FMCW radar for transmitting and receiving a radar signal modulated based on the FMCW scheme.

In operation 201, the radar signal processing apparatus may receive, through a reception antenna, a first reflection signal generated based on the radar signal reflected from the obstacle and a second reflection signal generated based on the radar signal reflected from the target located behind the obstacle. Each of the first reflection signal and the second reflection signal may be reflected from a different position and thus, may have different attributes. For example, each of the first reflection signal and the second reflection signal may have a different frequency, period, intensity, and phase. In operation 202, the radar signal processing apparatus may remove the first reflection signal based on the different attributes between the first reflection signal and the second reflection signal.

For example, when the radar signal is modulated based on the FMCW scheme, each of the first reflection signal and the second reflection signal may have a different frequency band. As an example, a frequency band of the second reflection signal reflected from the target located behind the obstacle may be higher than a frequency band of the first reflection signal reflected from the obstacle. Thus, the radar signal processing apparatus may filter out the first reflection signal using a high pass filter in which a frequency higher than the frequency band of the first reflection signal and lower than the frequency band of the second reflection band is set as a cut-off frequency.

The radar signal processing apparatus may receive the first reflection signal and the second reflection signal and mix a radar signal to the first reflection signal and the second reflection signal. Subsequently, the radar signal processing apparatus may determine a filtering band based on a frequency band of a result obtained by mixing the radar signal to the first reflection signal and a frequency band of a result obtained by mixing the radar signal to the second reflection signal.

For example, when the radar signal is modulated based on the FMCW scheme, the frequency bands of the first reflection signal and the second reflection signal may be proportional to a separation distance between the reception antenna and a reflection position. When the target is located behind the obstacle, the frequency band of the result obtained by mixing the radar signal to the first reflection signal may be lower than the frequency band of the result obtained by mixing the radar signal to the second reflection signal. Accordingly, the radar signal processing apparatus may filter out the result obtained by mixing the radar signal to the first reflection signal using a filter having a fixed filtering band or an adaptively adjusted filter.

In operation 203, the radar signal processing apparatus may extract location information on the target by processing the second reflection signal extracted based on a result of the filtering. The location information may include, for example, a separation distance between the target and the radar signal processing apparatus and a moving speed of the target.

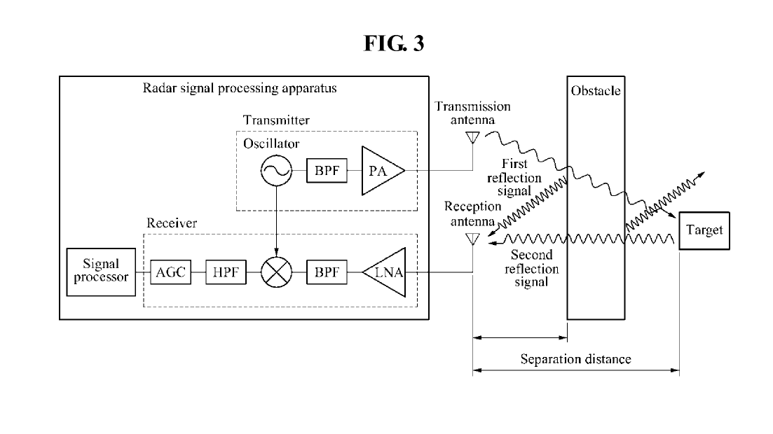

FIG. 3 is a diagram illustrating an antenna transmission processing apparatus for transmitting a radar signal to a target located behind an obstacle according to an example embodiment of the present invention.

Referring to FIG. 3, a radar signal processing apparatus may transmit a radar signal generated by an oscillator. For example, as illustrated in FIG. 3, the radar signal processing apparatus may transmit the radar signal through a band pass filter (BPF) to a target using a transmission antenna. In this example, a target may be located behind an obstacle.

The radar signal processing apparatus may receive a radar signal reflected from the obstacle through a reception antenna. In this example, the radar signal reflected from the obstacle may correspond to a first reflection signal. A radar signal penetrating the obstacle may be reflected by the obstacle. The radar signal reflected from the target may be transmitted to the radar signal processing apparatus by penetrating the obstacle again. In this example, the radar signal reflected by the target may also be reflected by the obstacle. The radar signal reflected from the target and penetrating the obstacle may correspond to a second reflection signal.

The radar signal processing apparatus may receive the first reflection signal and the second reflection signal through the reception antenna. The radar signal processing apparatus may mix the radar signal generated using the oscillator to each of the first reflection signal and the second reflection signal. Through this, the radar signal processing apparatus may filter a result of the mixing through the high pass filter. In this example, the high pass filter may have a fixed filtering band or an adaptively adjusted filtering band.

For example, a frequency of the radar signal modulated based on an FMCW scheme may increase proportionally to a separation distance. Thus, a frequency of the first reflection signal may be determined based on a separation distance between the radar signal processing apparatus and the obstacle. Also, a frequency of the second reflection signal may be determined based on a separation distance between the radar signal processing apparatus and the target.

In an example, the radar signal processing apparatus may filter out a signal reflected from an obstacle located within a predetermined separation distance using the high pass filter in which a fixed cut-off frequency is set. For example, when a result obtained by mixing the radar signal to the first reflection signal is lower than the cut-off frequency, and when a result obtained by mixing the radar signal to the second reflection signal is higher than the cut-off frequency, the radar signal processing apparatus may filter out the result obtained by mixing the radar signal to the first reflection signal.

Alternatively, the radar signal processing apparatus may adjust a filtering band based on the separation distance between the target and the radar signal processing apparatus. As illustrated in FIG. 3, when the target is located behind the obstacle, the frequency of the second reflection signal may be higher than the frequency of the first reflection signal. Thus, a frequency band of the result obtained by mixing the radar signal to the second reflection signal may be higher than a frequency band of the result obtained by mixing the radar signal to the first reflection signal. Accordingly, the radar signal processing apparatus may extract the result obtained by mixing the radar signal to the second reflection signal by adjusting the cut-off frequency of the high pass filter based on the separation distance between the target and the radar signal processing apparatus. The radar signal processing apparatus may determine location information on the target based on a result of the extracting. As an example, the radar signal processing apparatus may adjust the cut-off frequency based on the separation distance between the target and the radar signal processing apparatus by using an active high pass filter.

When the obstacle is located within a predetermined distance from the radar signal processing apparatus, the radar signal processing apparatus may filter out the result obtained by mixing the radar signal to the first reflection signal. In this example, the predetermined distance may indicate a maximum separation distance. For example, when the obstacle is located beyond the maximum separation distance, the frequency of the first reflection signal may be higher than the cut-off frequency of the radar signal processing apparatus. Thus, the radar signal processing apparatus may filter out the first reflection signal reflected from the obstacle located within the maximum separation distance. Also, when the obstacle is located within at least a predetermined distance from the radar signal processing apparatus, the radar signal processing apparatus may filter out the first reflection signal. In this example, the predetermined distance may indicate a minimum separation distance. Accordingly, a space between the minimum separation distance and the maximum separation distance may correspond to an adjustable separation range of the radar signal processing apparatus.

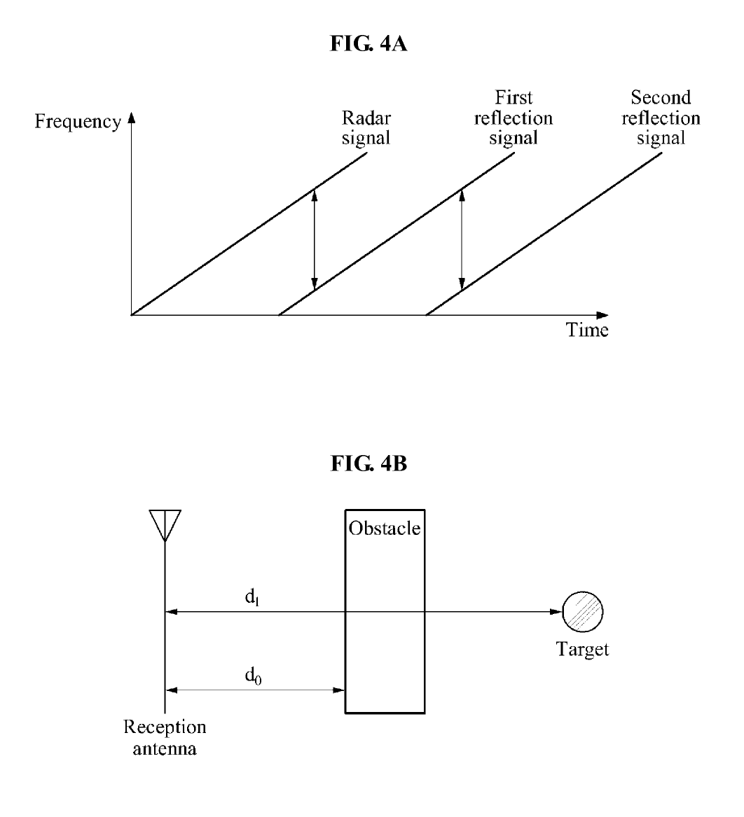

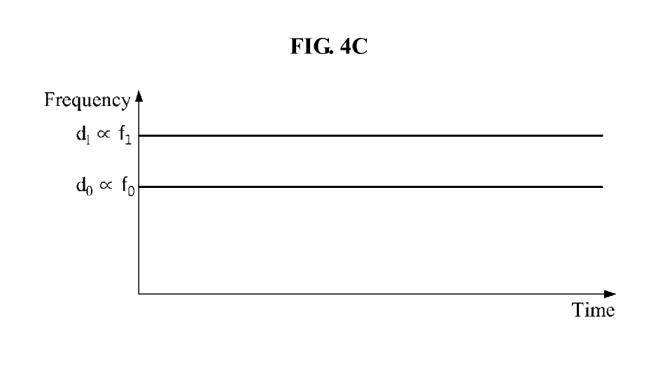

FIGS. 4A through 4C are diagrams illustrating a method of processing a radar signal modulated based on an FMCW according to an example embodiment of the present invention.

Referring to FIG. 4A, a frequency of a radar signal modulated based on the FMCW scheme may increase proportionally to a time. Thus, frequencies of a first reflection signal and a second reflection signal may also increase proportionally to a time. Referring to FIG. 4B, when a target is located behind an obstacle, a separation distance d₁ between the target and a reception antenna may be longer than a separation distance d₀ between the obstacle and the reception antenna. In this example, the frequency of the second reflection signal may be higher than the frequency of the first reflection signal. Accordingly, an amplitude of a frequency may be proportional to a separation distance between the reception antenna and a target from which the radar signal is reflected.

In this example, as illustrated in FIG. 3, a radar signal processing apparatus may mix a radar signal generated by an oscillator to the first reflection signal and the second reflection signal. Referring to FIG. 4C, a frequency f₀ of a result obtained by mixing the radar signal to the first reflection signal and a frequency f₁ of a result obtained by mixing the radar signal to the second reflection signal may be constant. For example, a frequency band of the result obtained by mixing the radar signal to the second reflection signal may differ from a frequency band of the result obtained by mixing the radar signal to the first reflection signal.

The radar signal processing apparatus may filter out a result obtained by mixing the radar signal to the first reflection signal based on a difference in the frequency band between the first reflection signal and the second reflection signal. For example, the radar signal processing apparatus may filter out the result obtained by mixing the radar signal to the first reflection signal using a high pass filter in which a fixed cut-off frequency is set. In this example, the radar signal processing apparatus may filter out a signal reflected from a target located within a separation distance corresponding to the cut-off frequency.

Alternatively, the radar signal processing apparatus may compare the separation distance from the target and the separation distance from the obstacle and adjust the cut-off frequency of the high pass filter, thereby filtering out the result obtained by mixing the radar signal to the first reflection signal. Through this, the radar signal processing apparatus may extract the result obtained by mixing the radar signal to the second reflection signal, thereby determining location information on the target. Although the filter using the frequency band is described as an example, the present disclosure is not limited thereto. Thus, the first reflection signal may be removed based on various differing attributes of the first reflection signal and the second reflection signal.

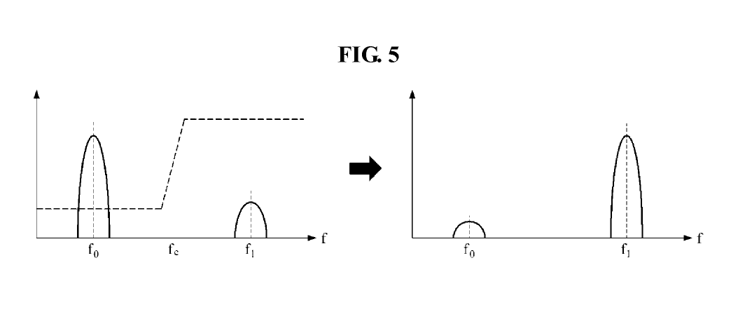

FIG. 5 is a diagram illustrating an example of performing filtering by using a filter for removing a first reflection signal according to an example embodiment of the present invention.

In a left graph of FIG. 5, f₀ may correspond to a center frequency of a result obtained by mixing a radar signal to a first reflection signal. Also, f₁ may correspond to a center frequency of a result obtained by mixing the radar signal to a second reflection signal.

f₀ and f₁ may be determined based on a separation distance between an reception antenna and an obstacle. The radar signal processing apparatus may filter out one of the result obtained by mixing the radar signal to the first reflection signal and the result obtained by mixing the radar signal to a second reflection signal based on a difference in a frequency band between the first reflection signal and the second reflection signal.

As an example, the radar signal processing apparatus may remove the result obtained by mixing the radar signal to the first reflection signal using a high pass filter having a fixed filtering band. Alternatively, the radar signal processing apparatus may determine a filtering band so as to remove the result obtained by mixing the radar signal to the first reflection signal by using a high pass filter having an adaptively adjusted filtering band. Through this, the radar signal processing apparatus may extract a desired result as shown in a right graph of FIG. 5.

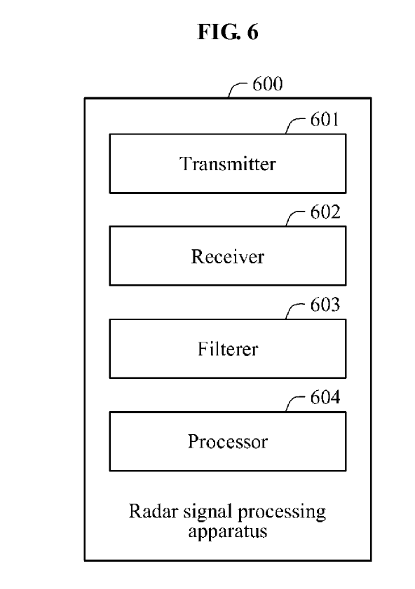

FIG. 6 is a block diagram illustrating a radar signal processing apparatus 600 for performing a method of processing a second reflection signal reflected from a target located behind an obstacle according to an example embodiment of the present invention.

A transmitter 601 may transmit a radar signal through a transmission antenna. For example, the transmitter 601 may transmit the radar signal to a target located behind an obstacle through the transmission antenna. The target may reflect a radar signal penetrating the obstacle.

The radar signal processing apparatus 600 may correspond to a radar. For example, the radar signal processing apparatus 600 may correspond to a transmission type radar for transmitting and receiving a radar signal penetrating the obstacle. As an example, the radar signal processing apparatus 600 may correspond to an FMCW radar for transmitting and receiving a radar signal modulated based on an FMCW scheme.

A receiver 602 may receive, through a reception antenna, a first reflection signal generated based on a radar signal reflected from the obstacle and a second reflection signal generated based on a radar signal reflected from the target located behind the obstacle. Each of the first reflection signal and the second reflection signal may be reflected from a different position and thus, may have different attributes. For example, each of the first reflection signal and the second reflection signal may have a different frequency, period, intensity, and phase. A filterer 603 may remove the first reflection signal based on the different attributes between the first reflection signal and the second reflection signal.

For example, when the radar signal is modulated based on the FMCW scheme, each of the first reflection signal and the second reflection signal may have a different frequency band. As an example, a frequency band of the second reflection signal reflected from the target located behind the obstacle may be higher than a frequency band of the first reflection signal reflected from the obstacle. Thus, the filterer 603 may filter the first reflection signal using a high pass filter in which a frequency higher than the frequency band of the first reflection signal and lower than the frequency band of the second reflection band is set as a cut-off frequency.

The radar signal processing apparatus 600 may receive the first reflection signal and the second reflection signal and mix a radar signal to the first reflection signal and the second reflection signal. Subsequently, the filterer 603 may determine a filtering band based on a frequency band of a result obtained by mixing the radar signal to the first reflection signal and a frequency band of a result obtained by mixing the radar signal to the second reflection signal.

For example, when the radar signal is modulated based on the FMCW scheme, the frequencies of the first reflection signal and the second reflection signal may be determined based on a separation distance between the reception antenna and a reflection position. In this example, the frequency band of the result obtained by mixing the radar signal to the first reflection signal may be less than the frequency band of the result obtained by mixing the radar signal to the second reflection signal. Accordingly, the radar signal processing apparatus may determine the filtering band based on the separation distance, thereby filtering out the result obtained by mixing the radar signal to the first reflection signal.

As an example, when the radar signal is modulated based on the FMCW scheme, the frequency bands of the result obtained by mixing the radar signal to the first reflection signal and the result obtained by mixing the radar signal to the second reflection signal may be constant. Thus, the second reflection signal extracted based on a result of the filtering may have a fixed frequency band. Through this, a processor 604 may extract location information on the target by processing the second reflection signal extracted based on the result of the filtering. The location information may include, for example, a separation distance between the target and the radar signal processing apparatus and a moving speed of the target.

According to an aspect of the present invention, it is possible to provide a radar signal processing method and apparatus for receiving a first reflection signal reflected from an obstacle and a second reflection signal reflected from a target located behind the obstacle, and filtering out the first reflection signal based on different attributes between the first reflection signal and the second reflection signal.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A radar signal processing method comprising:
transmitting a radar signal through a transmission antenna;
receiving, through a reception antenna, a first reflection signal generated based on the radar signal reflected by an obstacle and a second reflection signal generated based on the radar signal reflected by a target located behind the obstacle;
performing filtering by using a filter for removing the first reflection signal; and
processing the second reflection signal extracted based on a result of the filtering.

2. The method of claim 1, wherein the performing comprises performing the filtering based on a frequency band of a result obtained by mixing a radar signal to the first reflection signal and a frequency band of a result obtained by mixing a radar signal to the second reflection signal.

3. The method of claim 2, wherein the frequency band of the result obtained by mixing the radar signal to the first reflection signal is determined based on a separation distance between the reception antenna and the obstacle, and the frequency band of the result obtained by mixing the radar signal to the second reflection signal is determined based on a separation distance between the reception antenna and the target.

4. The method of claim 1, wherein the radar signal is modulated based on a frequency modulation continuous wave (FMCW) scheme.

5. The method of claim 1, wherein the performing comprises performing the filtering using a high pass filter for removing the first reflection signal.

6. A radar signal processing apparatus comprising:
a transmitter configured to transmit a radar signal through a transmission antenna;
a receiver configured to receive, through a reception antenna, a first reflection signal generated based on the radar signal reflected from an obstacle and a second reflection signal generated based on the radar signal reflected from a target located behind the obstacle;
a filterer configured to perform filtering using a filter for removing the first reflection signal; and
a processor configured to process the second reflection signal extracted based on a result of the filtering.

7. The apparatus of claim 6, wherein the filterer is configured to perform the filtering based on a frequency band of a result obtained by mixing a radar signal to the first reflection signal and a frequency band of a result obtained by mixing a radar signal to the second reflection signal.

8. The apparatus of claim 7, wherein the frequency band of the result obtained by mixing the radar signal to the first reflection signal is determined based on a separation distance between the reception antenna and the obstacle, and the frequency band of the result obtained by mixing the radar signal to the second reflection signal is determined based on a separation distance between the reception antenna and the target.

9. The apparatus of claim 6, wherein the radar signal is modulated based on a frequency modulation continuous wave (FMCW) scheme.

10. The apparatus of claim 6, wherein the performing comprises performing the filtering using a high pass filter for removing the first reflection signal.
